(19) United States
(12) Patent Application Publication
(10) Pub. No.: US 2019/0004146 A1
(43) Pub. Date: Jan. 3, 2019

(54) RADAR SENSOR

(71) Applicant: Hella GmbH & Co. KGaA, Lippstadt (DE)

(72) Inventor: Andreas von Rhein, Salzkotten (DE)

(21) Appl. No.: 16/067,712

(22) PCT Filed: Jan. 3, 2017
(86) PCT No.: PCT/EP2017/050085

§ 371 Date: Jul. 2, 2018

(30) Foreign Application Priority Data
Jan. 6, 2016 (DE) 10 2016 100 217.8

(51) Int. Cl. G01S 7/35; G01S 13/32; G01S 13/58; G01S 13/68; G01S 13/93

(52) U.S. Cl. CPC G01S 7/352; G01S 13/32; G01S 2007/356; G01S 13/68; G01S 13/931; G01S 13/583

(57) ABSTRACT

A radar sensor with a signal generation unit that generates a sequence of output signals for the generation of a radiated radar signal. The radar sensor has a signal receiving unit for the reception and for the processing of reflected radar signals as received signals, which are further processed for the analysis of the received signals. A sequence of voltage signals rising from a starting frequency are generated as output signal. The respective received signals are analyzed by means of Fourier analysis, and the output signals have a modulated starting frequency.

### CROSS REFERENCE

This application claims priority to PCT Application No. PCT/EP2017/050085, filed Jan. 3, 2017, which itself claims priority to German Patent Application 10 2016 100217.8, filed Jan. 6, 2016, the entirety of both of which are hereby incorporated by reference.

### FIELD OF THE INVENTION

The Invention relates to a radar sensor, such as in particular a radar sensor for a motor vehicle.

### BACKGROUND

Radar sensors are increasingly employed in motor vehicles. Such radar sensor are for example used in driver assistance systems, for example to detect oncoming vehicles safely at larger distances to determine their position and speed as accurately as possible. Radar sensors are also used to monitor the immediate environment of the motor vehicle.

The radar systems currently on the market vary for example with regard to their type of frequency modulation. When choosing the modulation type, the aim is to achieve a good resolution of the 3D-measuring room with the axes R, v and phi, which is in part empty and in other parts densely packed, in a complex environment. For each type of modulation, the resolution focus may be a different one.

To realize a frequency modulation of an yet unknown type, voltage-controlled oscillators (VCO) are used. When these VCOs are combined with other components in a housing, they are called MMICs.

The tuning frequency of these MMICs can be coarsely changed by a coarse control signal. The actual modulation is then executed via a fine control signal.

There are various types of modulation. In the following, only two of them will be dealt with: “slow-chirps” and “fast-chirps-sequence.” A chirp is a frequency rising over time in a linear manner. In both classes, the echo created on targets/objects, the received signal, is subjected to a Fourier analysis. High energy in various frequency positions of the received signals in this spectrum indicates a high probability for a real target in this frequency point, the so-called “bin”.

When the “slow-chirp” variant is used, only one 1D-Fourier transformation of the received signals is executed. Within a measuring frequency, the parameters R, v can herein not be clearly determined, as various R, v-combinations have the same spectral position (bin). This disadvantage can be corrected by using a small number of “slow chirps” with varying parametrization and/or by means of FSK modulation. Many targets will nevertheless coincide in the same spectral positions in a complex environment. So-called clutters develop. In a clutter, targets can no longer be found.

The “fast-chirp sequence” variant provides better target separation. Here, a large number of fast chirps is sent. First, the received signals per chirp are Fourier-transformed and then these 1D-spectrums are transformed beyond the number of chirps (2D Fourier analysis). The distance is read along the first axis of this 2D-R v-spectrum, and the speed is read along the second axis. There are only unambiguous R, v positions.

Both types of modulation are restricted with regard to unambiguousness in R and v. If the measuring scenario contains targets having a greater distance or speed than the unambiguousness-limits indicate, these targets flip to an undesired frequency range.

Good unambiguousness in R and v is desired, however.

The disadvantage of the fast-chirps sequence method over the slow-chirps sequence method is, that higher-quality components are required. The chirp-generation unit on or in the MMIC is required to work very fast to generate e.g. chirps with 30 μs intervals. The required scanning frequency of the ADC units, also called analog digital converter, also increases. This results in a much larger number of scanned values to be stored and processed in a central processing unit.

As technological development progresses, the requirements relating to fast-chirp sequence radar systems increase. To achieve a range discrimination of 0.04 m, very large chirp ranges of up to 4 GHz are desirable. At the same time, unambiguousness must not suffer, of course.

If a large bandwidth is covered within one chirp, the chirp generation units (DAC or PLL) in connection with the MIMIC or in it, quickly reach their limits. Chirp quality parameters, such as noise or linearity, will suffer. Also, the fine control input cannot cover the large bandwidth.

### SUMMARY OF THE INVENTION

Therefore it is the task of the present invention to develop a radar sensor which is improved with regard to the state of the art. Also, a respective procedure for the operation of such a radar sensor is to be developed.

Herein the task is also to find a form of modulation which does not cause noticeable additional requirements with regard to the scanner unit as well as to the central processing unit when compared to a standard fast-chirps sequence. Furthermore, it is desirable that the quality parameters of the chirp, such as linearity, shall be maintained when compared to the the standard sequence. The unambiguousness of speed and distance shall not be reduced either.

An embodiment of the invention relates to a radar sensor having a signal generation unit generating a sequence of output signals for the generation of a radiated radar signal, having a signal receiving unit for the reception and processing of reflected radar signals as received signals, which are further processed for the analysis of the received signals, wherein a sequence of voltage signals rising from an initial frequency is generated as output signals, wherein the respective received signals are analyzed by means of Fourier analysis, wherein the output signals have a modulated initial frequency. By this means, a better resolution is achieved, in particular with a comparable computing power. Herein, a modulated starting frequency means that the starting frequency does not remain the same, but varies, for example increases, increases in a linear manner, in a stepped manner, etc.

It is particularly advantageous if a speed of an object is determined by means of the Fourier analysis in direction of the dimension of the sequence of the voltage signals. By this means, the speed is determined in a simple manner.

It is also advantageous if a distance of an object is determined by means of the Fourier analysis in direction of the dimension of the voltage signal. By this means, the distance is determined in a simple manner.

Furthermore, it is advantageous if the angle of the object can be determined by means of a two-dimensional maximum detection and with the aid of a phase comparison or by means of digital beam-forming or high-resolution beam-forming of several aerials. By this means, not only distance and speed, but also the angle and therefore the current position can be fully determined.

According to the inventive idea it is also useful for the output signals to have an identical starting value and an identical end value and preferably run from F_c−f_band/2 to F_c+f_band/2. Herein F_c defines a mean value and f_band the bandwidth of the signal.

It is also advantageous for the output signals to have a starting value which is higher for each output signal and a higher final value. By this means, the signals differ from one another, which in turn leads to a better resolution.

Furthermore, it is also advantageous, if only every second output signal has a higher starting value and a higher final value, the output signals in between having a starting value and a final value which are identical with the previous signal. The voltage signals rise e.g. in a linear manner, wherein the next but one subsequent voltage signals are each offset on the voltage axis, so that the centers of individual voltage signals in turn rise essentially in a linear manner. In between, voltage signals are arranged, which correspond to the previous signal and which do not have a higher starting value. These output signals can be used again and from the respective reflected signals, the received signal can be analyzed by means of a Fourier analysis, the resulting error for the spatial resolution corresponding to the minor error of the 3800 MHz band.

When a Fourier analysis is executed, a corresponding Fast-Fourier analysis can be used, as a rule.

Here, it is also advantageous of the received, reflected radar signals are transformed in a lower intermediate frequency by means of mixers and subsequently scanned. Accordingly, it is also advantageous, if the scanned signal is used for further processing.

An embodiment of the invention relates to a procedure for the operation of a radar sensor according to the above description.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a representation of the generation of an output signal.

FIG. 2 is a diagram for the representation of output signals.

FIG. 3 is a representation for the explanation of a processing of received signals on the basis of the emitting signals in FIG. 2.

FIG. 4 is a diagram for the representation of output signals.

FIG. 5 is a representation for the explanation of a processing of received signals on the basis of the emitting signals in FIG. 4.

FIG. 6 is a diagram for the representation of output signals.

FIG. 7 is a representation for the explanation of a processing of received signals on the basis of the emitting signals in FIG. 6.

### DETAILED DESCRIPTION OF THE DRAWINGS

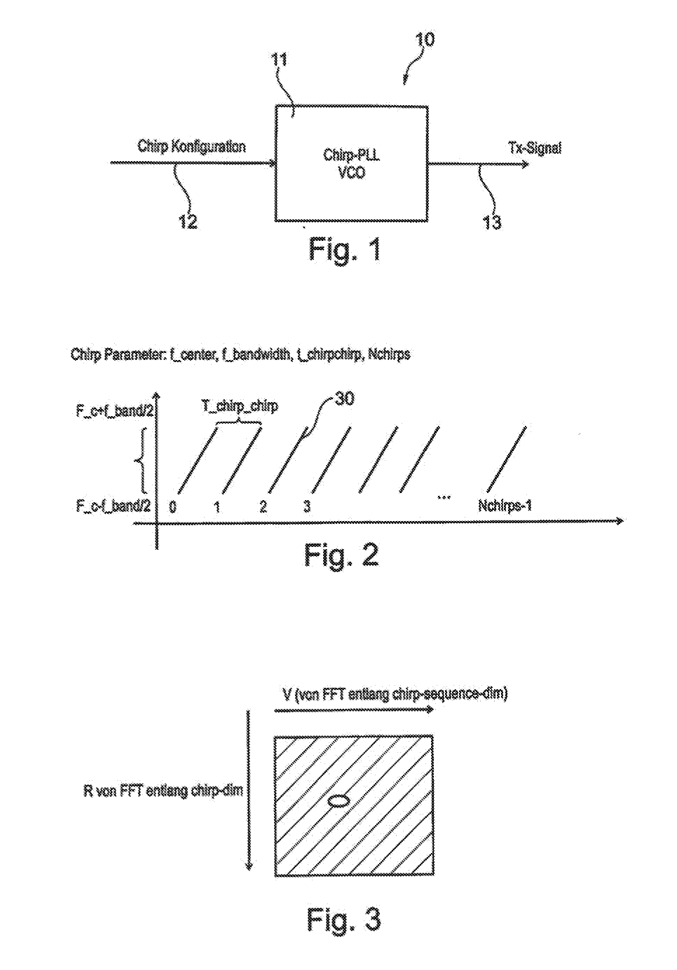

FIG. 1 shows a further configuration of a controller 10, which is embodied as a Voltage-Controlled Oscillator 11 by means of a Phase-Locked-Loop.

Due to the input signal 12, controlling is possible via the Voltage-Controlled Oscillator 11 so that the result is a desired output signal 13 as Tx-signal of the radar sensor. Herein, the Voltage-Controlled Oscillator 11 can be part of a microwave monolithic integrated circuit. This is also known as MMIC. Due to the specification of the shape of the voltage signals, the microwave monolithic integrated circuit can generate the respective voltage signals, also called chirps, with the Voltage-Controlled Oscillator.

Herein, FIG. 2 shows an example for an output signal with a multitude of rising voltage signals 30. The temporal interval of the rising voltage signals 30 is T_Chirp_Chirp. The voltage signal rises from F_c−f_band/2 to F_c+f_band/2. A number of N−1 of such rising signals is shown.

FIG. 3 shows a representation of how a distance- and speed determination can be executed from a 2-dimensional Fast-Fourier-Transform. Herein, the distance R as well as the speed v are determined from the 2-dimensional Fast-Fourier-Transform of the rising voltage signals. By means of a phase comparison between several aerials, the angle of the object can also be determined from the 2-dimensional maximum detection.

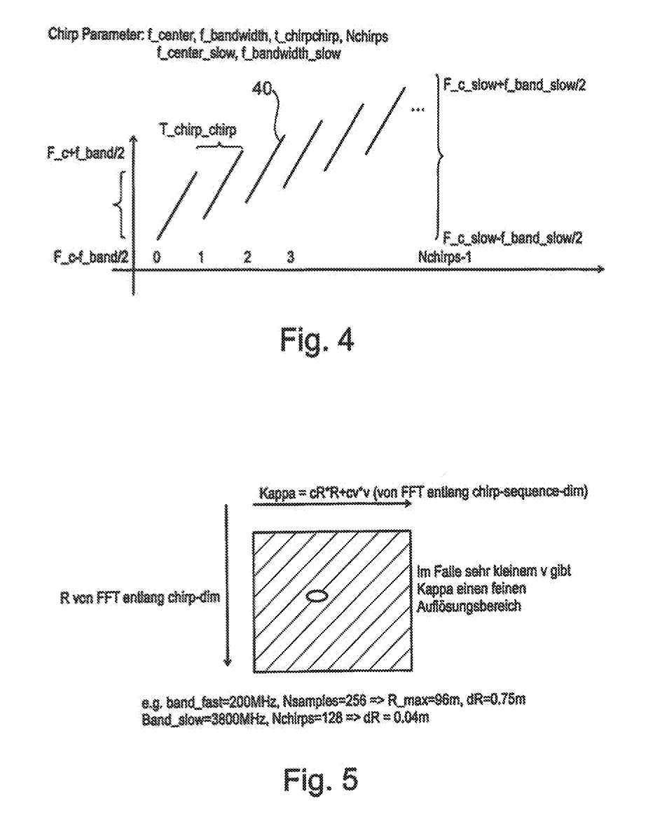

Accordingly, a sequence of rising voltage signals 40 is suggested, as can be seen in FIG. 4. The voltage signals rise essentially in a linear manner, wherein succeeding voltage signals are each off-set on the voltage-axis, so that the centers of the individual voltage signals rise essentially in a linear manner.

The first voltage signal rises essentially in alinear manner from F_c−f_band/2 to F_c+f_band/2.

The output signal, from which the relevant voltage signal starts to raise, runs from F_c_slow−f_band_slow/2 to F_c_slow+f_band_slow/2.

FIG. 5 shows a representation of how a 2-dimensional Fast-Fourier Transform can be used for a distance and speed determination. Herein, the distance R as well as the speed v are determined by means of the 2-dimensional Fast-Fourier Transform of the rising voltage signals according to FIG. 4. The angle of the object can be determined from the 2-dimensional maximum detection by means of a phase comparison between several aerials.

For small v, the value Kappa=cR*R+cv*v results in a resolution for R with dR relatively small and in the range of dR=0.04 m in the 3800 MHz band and dR=0.75 m in the 200 MHz band.

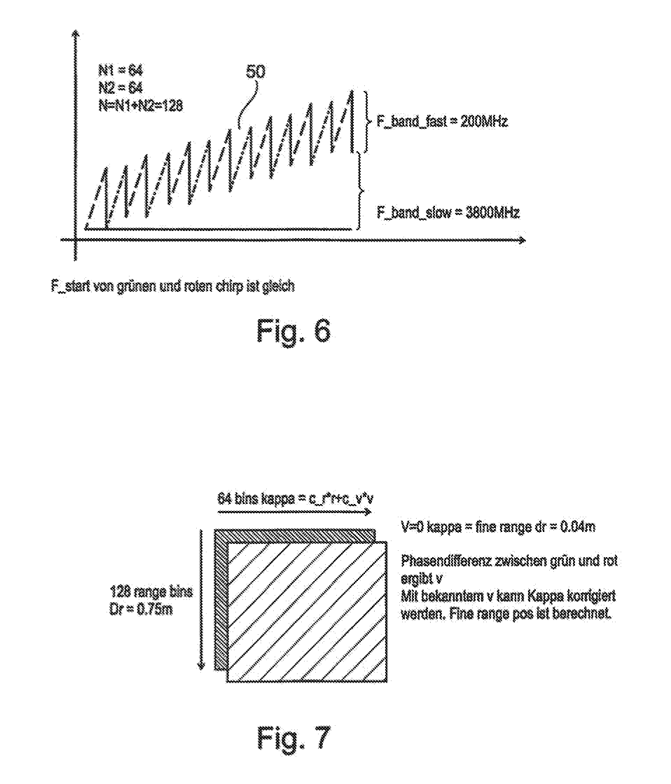

Furthermore, a sequence of rising voltage signals 50 is proposed, as is shown in FIG. 6. Herein, the voltage signals are alternatingly voltage signals similar to FIG. 2 and similar to FIG. 4.

The voltage signal rise essentially in a linear manner, the next but one subsequent voltage signals are always set off on the voltage axis, so that the centers of the individual voltage signals in turn rise essentially in a linear manner. In between, voltage signals are arranged which are identical with the previous signal and which do not have a rising initial value.

These output signals are subsequently inserted again and the receiving signal can be determined from the reflected signals by means of a Fast-Fourier Analysis, the separating efficiency in the spot concerned corresponds to that in the 3800 MHz band, see FIG. 7.

Another form of rising voltage signals, which are also called chirp forms, are chirp sequence ramps, such as for example shown in FIG. 2. Herein, the individual rising voltage signals, also called chirps, scan an effective bandwidth of for example approx. 200 MHz.

Within this effective bandwidth, the received data are scanned in the IF-band. The Fourier Transform along the conversion data of a chirp result in a 1D-range spectrum. If several chirp sequences, for example 128 of such chirp sequences, are sent one after the other, a Fourier Transform can again be executed along one range bin at a time. The result of the 2D-spectrum results in a 2D-Rv image, see FIG. 3.

If a multitude of Rx aerials is available, a further Fourier Transform along the Rx-axis results in a 3D-Rv,phi image. These images are searched for characteristic maxima to distinguish targets in the environment from noise. The simplest method is the local maxima search. A peak position is clearly described in the 2D-Rv image with (Rbin, vbin).

Known chirp-generators can generate chirp bandwidths of up to 500 MHz. If the chirp bandwidth is increased, chirp quality suffers. Also, the scanning rate of the ADC converters needs to be significantly increased with increasing bandwidth, or the chirp-steepness is reduced. The result is that more data are recorded or poorer measuring parameters, such as speed unambiguousness, are available.

Chirp generators according to the invention can generate almost any chirp sequence due to intelligent and programmable PLL-components, see FIG. 1. Nevertheless, these chirp forms are subject to certain limits. The bandwidth of the individual chirps should not be too large.

It is assumed that a random chirp sequence is generated via Vcoarse and Vfine as described above or via a PLL, see FIG. 1. The corresponding chirp sequence should at least essentially look like the ones shown in FIG. 4 or 6.

Herein, it is advantageous that the bandwidth of the individual chirps is small, for example approx. 200 MHz. The distance between two chirps T_Chirp_Chirp shall be approx. 30 μs to reach a high degree of speed unambiguousness.

The scanned bandwidth of the slow-chirp lying beyond this is large, such as for example 800 MHz. With these two parameters, the 1-GHz-band is covered completely at 76.5 GHz center-frequency. After the 2D-transformation of the ADC-data, a R-kappa-image is available instead of a R-v-image.

The parameters can also be variegated. If the individual chirp is left at 200 MHz, the center-frequency is set to 79 GHz and the slow-chirp-bandwidth to 3800 MHz, a high-resolution range-kappa image is available, see FIG. 5.

The range unambiguousness remains the same, as in FIG. 3 representing the procedure described above, wherein the further advantage of the high degree of range discrimination of approx. 4 cm is achieved.

The speed measurement capability can be achieved relatively easily by means of the variant in FIG. 6. In FIG. 6, two chirps following one after the other have the same starting frequency. The next 2-chirp block can directly follow with an off-set starting frequency, see FIG. 6, or with a pause of for example one T_pause=T_Chirp_Chirp in between.

Herein, the measuring data of the alternatingly rising ramps, resp. chirps, are separately 2D-Fourier-transformed. If a target is detected in one of the spectra (Rbin_coarse, kappa), it will also be detected in a different spectrum in the same position. The phase difference between the two spectra in this position is proportional to the speed. By means of the speed which has now been determined, the speed in kappa can be subtracted to achieve a Rbin_fine=kappa−vbin. You receive the measuring point (Rbin_coarse, Rbin_fine). The unambiguousness is clearly lower in direction “fine” than in direction “coarse”. The ambiguousness can be re-establised by a simple plausibilization with the help of the known unambiguousness limit between “coarse” and “fine”.

Here, a consistent number of measuring data is advantageous. Related to this is the consistent requirement on computing power. Also, a relatively large range separability with sufficient unambiguousnesses is achieved. In the above example with R_max=200 m with dr=0.04 m.

### LIST OF REFERENCE SIGNS

10 Controller
11 Oscillator
12 Input signal
13 Output signal
30 Voltage signal
40 Voltage signal
50 Voltage signal

1. A radar sensor comprising:
a signal generation unit for generating a sequence of output signals having a modulated starting frequency for the generation of a radiated radar signal;
a signal receiving unit for the reception and for the processing of reflected radar signals as received signals,
wherein said received signals are further processed for the analysis of the received signals,
wherein a sequence of voltage signals rising from a starting frequency are generated as output signal, and
wherein the respective received signals are analyzed by means of Fourier analysis.

2. The radar sensor according to claim 1, wherein from the Fourier analysis, a speed of an object is determined in a direction of a dimension of the sequence of the voltage signals.

3. The radar sensor according to claim 1, wherein from the Fourier analysis, a distance of an object is determined in a direction of a dimension of the sequence of the voltage signals.

4. The radar sensor according to claim 1, wherein the angle of the object is determined by means of a two-dimensional maximum detection and by means of at least one of a phase comparison and a high-resolution-beam-forming of several aerials.

5. The radar sensor according to claim 1 wherein the output signals have an identical starting value and an identical end value and run from F_c−f_band/2 to F_c+f_band/2.

6. The radar sensor according to claim 1 wherein the output signals have a starting value which is raised from output signal to output signal and a raising end value.

7. The radar sensor according to claim 1 wherein only every second output signal has a raised starting value and a raising end value, wherein the output signals in between have at least one of a starting value and an end value which is identical with the previous signal.

8. The radar sensor according to claim 1, wherein the received reflected radar signals are transformed into a lower intermediate frequency by means of a frequency mixer and are subsequently scanned.

9. The radar sensor according to claim 8, wherein the scanned signal is used for further processing.

10. (canceled)
